(19) United States
(12) Patent Application Publication
(10) Pub. No.: US 2025/0249431 A1
(43) Pub. Date: Aug. 7, 2025

(54) METAL-ORGANIC FRAMEWORK FILM AND METHOD FOR PRODUCING SAME

(71) Applicant: Murata Manufacturing Co., Ltd., Nagaokakyo-shi (JP)

(72) Inventor: Hideaki OOE, Nagaokakyo-shi (JP)

(21) Appl. No.: 19/087,809

(22) Filed: Mar. 24, 2025

Related U.S. Application Data
(63) Continuation of application No. PCT/JP2023/028969, filed on Aug. 8, 2023.

(30) Foreign Application Priority Data
Nov. 22, 2022 (JP) 2022-186639

(51) Int. Cl. B01J 20/28; B01J 20/32

(52) U.S. Cl. CPC B01J 20/28033; B01J 20/28007; B01J 20/28016; B01J 20/3204; B01J 20/3221; B01J 20/3265; B01J 20/3293

(57) ABSTRACT

A metal-organic framework film having: a base; and protrusions extending from a surface of the base, the protrusions having an average adjacent distance p of 1 nm to 100 nm. The protrusions preferably have an average depth d of 1 nm to 100 nm, and the metal-organic framework film preferably has a film thickness t of 10 nm to 1000 nm.

### CROSS REFERENCE TO RELATED APPLICATIONS

The present application is a continuation of International application No. PCT/JP2023/028969, filed Aug. 8, 2023, which claims priority to Japanese Patent Application No. 2022-186639, filed Nov. 22, 2022, the entire contents of each of which are incorporated herein by reference.

### TECHNICAL FIELD

The present description relates to a metal-organic framework film and a method for producing the same.

### BACKGROUND ART

Conventionally, attempts have been made to collect gas such as carbon dioxide with an adsorbing material. As the adsorbing material, a metal-organic framework (MOF), an amine compound, and the like are known (Patent Documents 1 to 4).

For example, Patent Document 1 discloses that a metal oxide is used as a precursor, and the metal oxide is converted into a MOF to form a MOF film.

For example, Patent Document 2 proposes a carbon dioxide-adsorbing agent in which an amine compound is supported on porous particles in which a hydrophilic fiber and a porous powder are combined with a hydrophilic binder. As the porous powder, a MOF is used. It is described that the void (pore size) is adjusted to 1 μm to 20 μm in order to improve the carbon dioxide adsorption rate.

In addition, for example, Patent Document 3 describes a carbon dioxide-adsorbing material in which polyamine is supported on a composite film of a metal oxide film and a MOF.

For example, Patent Document 4 describes that a silica-based gas-adsorbing material having pores of about 100 nm can provide an effect of improving a specific surface area (that is, an effect of increasing CO₂ adsorption sites (adsorption amount)).

Patent Document 1: Japanese Translation of PCT International Application Publication No. 2017-519896

Patent Document 2: Japanese Patent Application Laid-Open No. 2018-187574

Patent Document 3: WO 2021/261271A

Patent Document 4: Japanese Patent Application Laid-Open No. 2021-095306

### SUMMARY OF THE DESCRIPTION

However, the inventor of the present description has found that conventional techniques cause the following new problems.

(1) In the techniques of Patent Documents 1 and 3, the MOF has a uniform pore shape and high crystallinity as illustrated in FIG. 13. Thus, not only the contact probability between the MOF and gas is relatively low, but also the diffusion rate of the gas G into the crystal is low. As a result, there is a problem that the gas adsorption rate is low. FIG. 13 is a schematic diagram of a MOF schematically illustrating a crystal structure of a MOF according to an example of conventional techniques. In FIG. 13, MA represents a metal atom (in particular, a metal atom ion), and OM represents an organic molecule.

(2) In the technique of Patent Document 2, since the gas-adsorbing material is molded using the binder, the binder component B enters the MOF pores as illustrated in FIG. 14, and the gas adsorption performance is deteriorated. Thus, there is a problem that the gas adsorption rate is low. FIG. 14 is a schematic diagram of a MOF schematically illustrating a crystal structure of a MOF according to another example of conventional techniques. In FIG. 14, MA represents a metal atom (in particular, a metal atom ion), and OM represents an organic molecule.

(3) In the technique of Patent Document 4, since gas does not enter the inside of the silica-based gas-adsorbing material, only the surface of the gas-adsorbing material contributes to gas adsorption. Thus, the gas adsorption rate is low.

It is an object of the present description to provide a metal-organic framework (MOF) film having a higher gas adsorption rate.

The present description relates to a metal-organic framework film having: a base; and protrusions extending from a surface of the base, the protrusions having an average adjacent distance p of 1 nm to 100 nm.

The present description also relates to a method for producing a metal-organic framework film, the method including: performing heating and application of an ultrasonic wave while immersing a metal oxide in a solution containing organic molecules.

The metal-organic framework film of the present description exhibits a higher gas adsorption rate. Since the metal-organic framework film of the present description has a sufficiently large surface area, the probability of contact with gas is relatively high. The metal-organic framework film of the present description also has sufficiently and appropriately many lattice defects, whereby gas easily enters the crystal lattice and gas easily diffuses. As a result, it is considered that the metal-organic framework film of the present description has a sufficiently high gas adsorption rate.

### BRIEF DESCRIPTION OF THE DRAWINGS

FIG. 1A is a schematic sectional view for explaining an example of a structure of a metal oxide having a metal-organic framework film of the present description.

FIG. 1B is a schematic enlarged perspective view of a metal-organic framework film for explaining a structure of a metal-organic framework film of the present description, and is a schematic enlarged view of a portion X in FIG. 1A.

FIG. 1C is a schematic diagram of a metal-organic framework schematically illustrating a crystal structure of a metal-organic framework film according to the present description.

FIG. 1D is a schematic diagram of a metal-organic framework schematically illustrating a crystal structure of a metal-organic framework film according to the present description using 2-methylimidazole as an organic molecule.

FIG. 2A is a schematic plan view of an example of a gas sensor according to a second embodiment of the present description.

FIG. 2B is a schematic sectional view of an example of a gas sensor according to a second embodiment of the present description.

FIG. 2C is a schematic process view illustrating a method of producing a gas sensor according to a second embodiment of the present description.

FIG. 2D is a schematic plan view of an example of a multi-gas sensor according to a second embodiment of the present description.

FIG. 2E is a schematic sectional view of an example of a multi-gas sensor according to a second embodiment of the present description.

FIG. 2F is a schematic diagram of an example of a gas adsorption filter according to a third embodiment of the present description.

FIG. 2G is a schematic diagram of an example of a gas removal device according to a fourth embodiment of the present description.

FIG. 3A is a schematic perspective view of a gas adsorption filter produced in the example.

FIG. 3B is a graph in which (1) shows an XRD spectrum of a metal-organic framework (ZIF-8) alone, (2) shows an XRD spectrum of a sample in which a metal-organic framework (ZIF-8) film is formed on zinc oxide (ZnO), and (3) shows an XRD spectrum of zinc oxide (ZnO) alone.

FIG. 4A is a SEM photograph (5000×) of a sample collected from an outer surface of the gas adsorption filter produced in Example 1.

FIG. 4B is a SEM photograph (200,000×) obtained by further enlarging a part of the sample collected from an outer surface of the gas adsorption filter produced in Example 1.

FIG. 5A is a SEM photograph (5000×) of a sample collected from an outer surface of the gas adsorption filter produced in Example 2.

FIG. 5B is a SEM photograph (200,000×) obtained by further enlarging a part of the sample collected from an outer surface of the gas adsorption filter produced in Example 2.

FIG. 6A is a SEM photograph (5000×) of a sample collected from an outer surface of the gas adsorption filter produced in Comparative Example 1.

FIG. 6B is a SEM photograph (200,000×) obtained by further enlarging a part of the sample collected from an outer surface of the gas adsorption filter produced in Comparative Example 1.

FIG. 7A is a SEM photograph (1000×) of a sample collected from an outer surface of the gas adsorption filter produced in Comparative Example 2.

FIG. 7B is a SEM photograph (200,000×) obtained by further enlarging a part of the sample collected from an outer surface of the gas adsorption filter produced in Comparative Example 2.

FIG. 8A is a SEM photograph (5000×) of a sample collected from an outer surface of the gas adsorption filter produced in Comparative Example 4.

FIG. 8B is a SEM photograph (200,000×) obtained by further enlarging a part of the sample collected from an outer surface of the gas adsorption filter produced in Comparative Example 4.

FIG. 9A is a SEM photograph (5000×) of a sample collected from an outer surface of the gas adsorption filter produced in Comparative Example 5.

FIG. 9B is a SEM photograph (200,000×) obtained by further enlarging a part of the sample collected from an outer surface of the gas adsorption filter produced in Comparative Example 5.

FIG. 10 is a graph showing evaluation results of the gas adsorption test in the examples and the comparative examples.

FIG. 11 is a schematic diagram of a metal-organic framework schematically illustrating a crystal structure of an actual metal-organic framework.

FIG. 12 is a graph showing a relationship between a gap dimension and a diffusion resistance.

FIG. 13 is a schematic diagram of a metal-organic framework schematically illustrating a crystal structure of a metal-organic framework according to an example of conventional techniques.

FIG. 14 is a schematic diagram of a metal-organic framework schematically illustrating a crystal structure of a metal-organic framework according to another example of conventional techniques.

### DESCRIPTION OF THE PREFERRED EMBODIMENTS

### First Embodiment

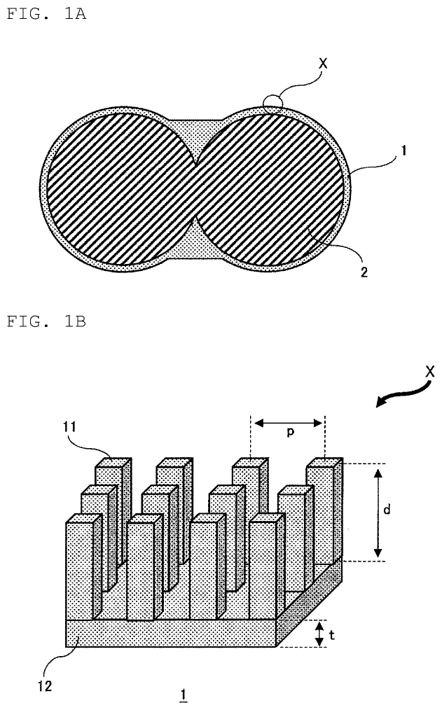

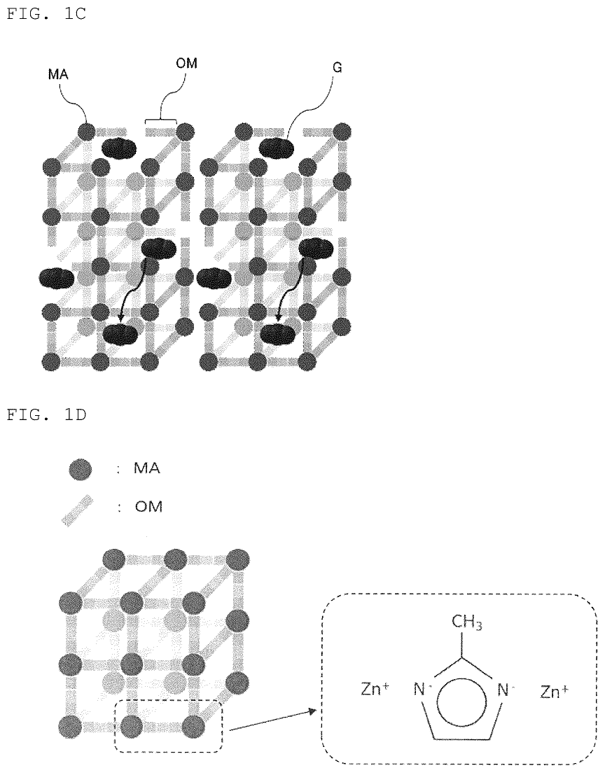

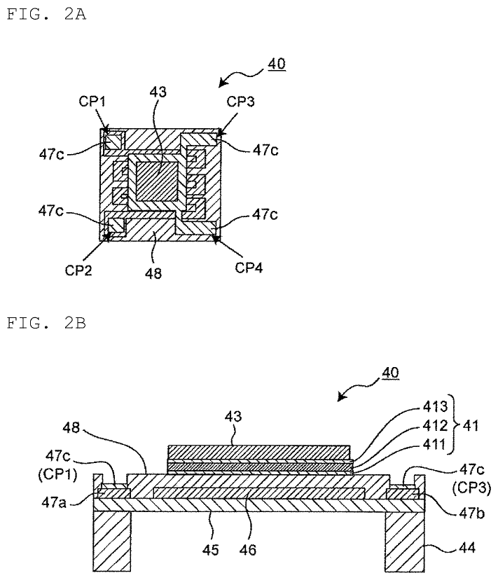

A first embodiment of the present description provides a metal-organic framework film (hereinafter, sometimes referred to as MOF film). The MOF film of the present description has a surface covered with protrusions and has a nano-protrusion structure on the surface. Specifically, as illustrated in FIG. 1A, the MOF film 1 is usually disposed (or formed) on the surface of the metal oxide 2, and the surface of the MOF film 1 is covered with protrusions 11 having a nano-order size as illustrated in FIG. 1B. FIG. 1A is a schematic sectional view for explaining an example of a structure of a metal oxide having the metal-organic framework film of the present description. FIG. 1B is a schematic enlarged perspective view of the metal-organic framework film for explaining the structure of the metal-organic framework film of the present description, and is a schematic enlarged view of a portion X in FIG. 1A. In the present description, various elements in the drawings are merely shown schematically and exemplarily for the understanding of the present description, and appearance, dimensional ratios, and the like may be different from actual ones. “Vertical direction”, “horizontal direction”, and “front-back direction” used directly or indirectly in the present description correspond to directions corresponding to the vertical direction, the horizontal direction, and the front-back direction in the drawings, respectively, unless otherwise specified. The same reference numerals or symbols denote the same members or the same meaning unless otherwise specified, and may have different shapes.

The surface being covered with the protrusions means that a plurality of protrusions (or protrusion portions) is relatively densely formed on one surface (usually, the surface opposite to the metal oxide 2 side (hereinafter, sometimes referred to as “outer surface”)) of the MOF film 1. Since the surface is covered with the protrusions, the proportion of the MOF crystal surface (a portion where metal atoms or organic molecules are exposed) relatively increases. As a result, the entry of gas into the MOF film is promoted. Thus, the gas adsorption rate is improved.

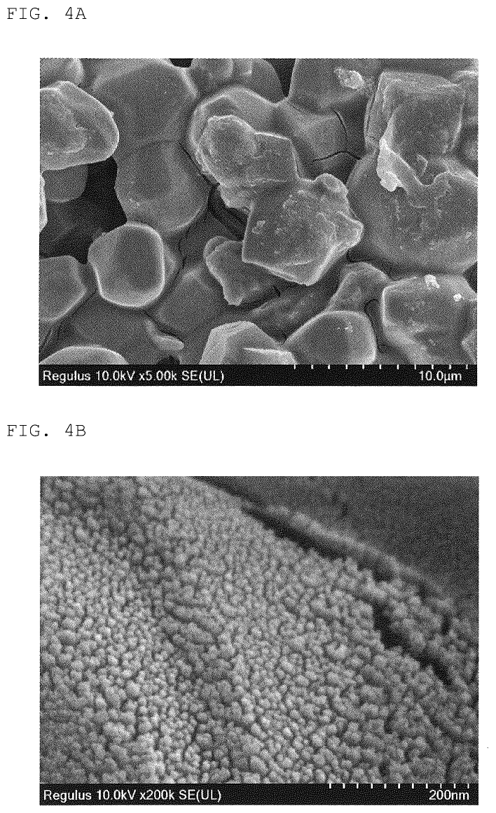

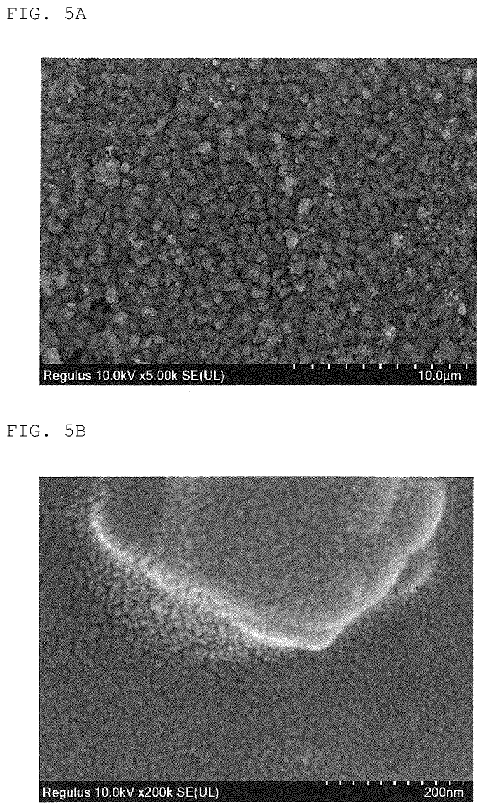

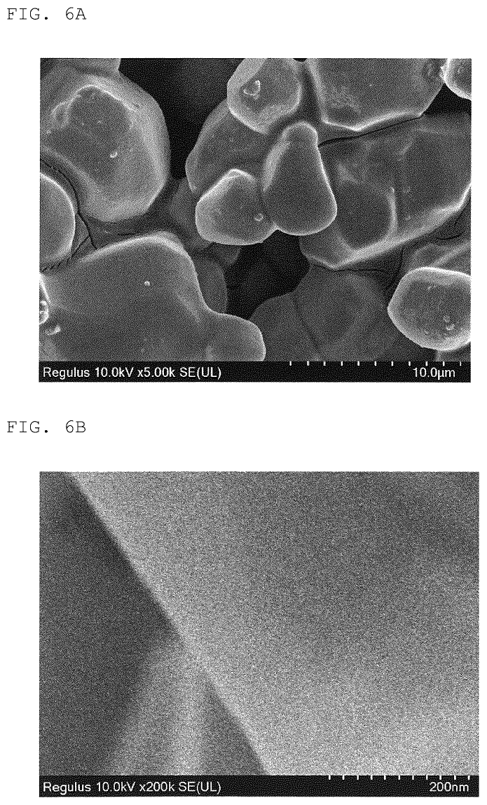

The degree of “density” of the protrusions is not particularly limited as long as the effect of the present description can be obtained. For example, as shown in the SEM images of FIGS. 4B and 5B taken in the examples described later, the protrusions may be usually formed densely on the outer surface to the extent that villi exist on the inner surface of the small intestine. Specifically, the average adjacent distance p of the protrusions is usually 1 nm to 100 nm, and from the viewpoint of further improving the gas adsorption rate, the average adjacent distance p is preferably 1 nm to 50 nm, more preferably 5 nm to 50 nm, still more preferably 10 nm to 30 nm, and particularly preferably 17 nm to 25 nm. If the average adjacent distance is too long, the gas adsorption rate decreases.

The average adjacent distance p is, for example, an average value for the distance between any two adjacent protrusions as illustrated in FIG. 1B. Specifically, the distance between the two protrusions may be a distance between apexes of the two protrusions. In the present description, as the average adjacent distance, an average value obtained by measuring the distance between two protrusions in each of 100 random sets in the SEM image showing the section of the MOF film is used. The SEM image showing the section of the MOF film can be obtained by milling the surface with a focused ion beam (FIB) to expose the section and performing SEM observation. It is also possible to measure the sectional shape and the interval between the protrusions by a transmission electron microscope (TEM) instead of the SEM.

The MOF film usually has protrusions 11 and a base 12 supporting the protrusions 11, and both the protrusions 11 and the base 12 are formed of a MOF.

The protrusions 11 usually have an average depth d of 1 nm to 100 nm. From the viewpoint of further improving the gas adsorption rate, the average depth d is preferably 1 nm to 50 nm, more preferably 5 nm to 50 nm, still more preferably 10 nm to 40 nm, and particularly preferably 20 nm to 30 nm.

The average depth d is a characteristic value related to the depth (height) from the apex of the protrusion 11 to the base 12, for example, as illustrated in FIG. 1B. In the present description, as the average depth d, an average value obtained by measuring depths (heights) of 100 random protrusions in a SEM image showing a section of the MOF film is used. The SEM image showing the section of the MOF film may be the same as the SEM image showing the section of the MOF film in measurement of the average adjacent distance p.

The base 12 usually has an average film thickness t of 1 nm to 1000 nm. From the viewpoint of further improving the gas adsorption rate, the average film thickness t is preferably 1 nm to 500 nm, more preferably 5 nm to 200 nm, still more preferably 10 nm to 90 nm, yet still more preferably 20 nm to 80 nm, and further preferably 30 nm to 80 nm.

The average film thickness t is a characteristic value regarding the thickness at the base 12, for example, as illustrated in FIG. 1B. In the present description, the average film thickness t is an average value obtained by measuring the thicknesses immediately below 100 random protrusions in the SEM image showing the section of the MOF film. The SEM image showing the section of the MOF film may be the same as the SEM image showing the section of the MOF film in measurement of the average adjacent distance p.

The protrusions 11 only need to be formed relatively densely in at least a partial region on the outer surface of the MOF film, and are preferably formed relatively densely over the whole outer surface (or entire surface) from the viewpoint of further improving the gas adsorption rate.

The MOF film 1 is usually disposed (or formed) in direct contact with the surface of the metal oxide 2 as illustrated in FIG. 1A. Specifically, the MOF of the MOF film 1 may be configured using metal atoms constituting the metal oxide 2. Thus, the MOF film 1 may be referred to as “altered film” (or “altered layer”). That is, the alteration in the “altered film” means chemical alteration of the metal oxide 2, and the “altered film” may be a film (or layer) in which a MOF is formed using metal atoms of the metal oxide 2. More specifically, metal atoms shared by the metal oxide and the MOF are present at the interface of (or between) the metal oxide 2 and the MOF of the MOF film 1. For example, metal atoms constituting both the metal oxide and the MOF are present at the interface. Further, for example, in the altered film, the MOF is constructed while incorporating metal atoms constituting the metal oxide. As a result thereof, metal atoms are shared by both the metal oxide and the MOF between the metal oxide and the MOF (for example, at the interface). In the present description, since the MOF is formed on the surface of the metal oxide while sharing the metal atoms of the metal oxide as described above, the adhesion of the MOF film is sufficiently improved. At the interface between the metal oxide 2 and the MOF constituting the MOF film 1, metal atoms are shared by the metal oxide and the MOF.

The metal oxide 2 is not particularly limited as long as it is a metal oxide capable of providing metal atoms capable of constituting the MOF, and examples thereof include one or more metal oxides selected from the group consisting of zinc oxide, copper oxide, nickel oxide, iron oxide, indium oxide, and aluminum oxide. The metal oxide 2 is preferably composed of zinc oxide from the viewpoint of further improving the gas adsorption rate.

The metal oxide 2 has a form in which two particles are connected in FIG. 1A, but may have a form of one particle or a form of a molded body or a molded sintered body of a plurality of particles. The molded body of the plurality of particles is produced by a known method such as an extrusion molding method, and may contain a binder for linking between the particles. The molded sintered body of a plurality of particles is produced by sintering a molded body of a plurality of particles, and thus does not contain a binder. From the viewpoint of further improving the gas adsorption rate, the metal oxide 2 preferably has the form of a molded body or a molded sintered body of a plurality of particles, and more preferably has the form of a molded sintered body. When the metal oxide 2 has a form of a molded body or a molded sintered body of a plurality of particles, the metal oxide 2 has a porous structure.

The average primary particle size of the particles constituting the metal oxide 2 is usually 1 μm to 25 μm, and from the viewpoint of further improving the gas adsorption rate, the average primary particle size is preferably 2 μm to 25 μm, more preferably 2 μm to 20 μm, still more preferably 5 μm to 20 μm, and particularly preferably 6 μm to 15 μm.

The average primary particle size of the metal oxide 2 can be determined by averaging the particle sizes of 50 random particles constituting the metal oxide 2 in the SEM image showing the section of the MOF film. The SEM image showing the section of the MOF film may be the same as the SEM image showing the section of the MOF film in measurement of the average adjacent distance p.

In the present description, since the gas adsorption rate of the MOF film 1 is sufficiently favorable, the MOF film 1 alone may be referred to as “gas-adsorbing material”, or a material including at least the MOF film 1 and a metal oxide supporting the MOF film 1 as constituent elements may be referred to as “gas-adsorbing material”.

The MOF film 1 includes a MOF, and is usually composed of only MOF. The fact that the MOF film 1 is composed only of the MOF means that substances other than the MOF are not intentionally contained, and for example, unintended substances such as metal atoms and organic molecules constituting the MOF and impurity substances may be contained.

Specifically, the MOF film 1 is a porous film based on coordinate bonds between organic molecules and metal atoms including a metal atom derived from the metal oxide 2. More specifically, the MOF constituting the MOF film 1 is a MOF based on coordinate bonds between organic molecules and metal atoms including a metal atom derived from the metal oxide 2, and the MOF film 1 is configured as a porous film. The MOF is, for example, as illustrated in FIG. 1C, a crystalline complex formed by crosslinking a metal atom (in particular, a metal atom ion) MA with an organic molecule OM as a ligand, and is a porous body based on a coordinate bond between the organic molecule and the metal atom (in particular, metal atom ion). In the MOF, not all metal atoms constituting the MOF have to be shared by the metal oxide 2. Metal atoms of at least the MOF adjacent to the metal oxide (or at least the MOF in the vicinity of the metal oxide) only need to be shared by the metal oxide. The state in which the metal atoms of the MOF adjacent to the metal oxide are shared by the metal oxide can be confirmed by observation under high magnification (for example, 1 million times or more) with a transmission electron microscope (TEM). FIG. 1C is a schematic diagram of a MOF schematically illustrating a crystal structure of a MOF film according to the present description.

Specifically, for example, a MOF containing 2-methylimidazole described later as an organic molecule and a zinc atom as a metal atom may have a crystal structure as illustrated in FIG. 1D. At this time, any one or more of the 18 zinc atoms MA shown in FIG. 1D may be shared by the metal oxide. FIG. 1D is a schematic diagram of a MOF schematically illustrating a crystal structure of a MOF film according to the present description using 2-methylimidazole as an organic molecule. This structure is merely a schematic diagram, and the crystal structure is accurately described, for example, in the following documents.

ANH PHAN et al., “Synthesis, Structure, and Carbon Dioxide Capture Properties of Zeolitic Imidazolate Frameworks” (ACCOUNTS OF CHEMICAL RESEARCH 58 67 January 2010 Vol. 43, No. 1)

The organic molecule may be any organic molecule known as an organic molecule capable of constituting a MOF in the MOF field. From the viewpoint of further improving the gas adsorption rate, the organic molecules preferably include one or more organic molecules selected from the group consisting of azole-based organic molecules, cyan-based organic molecules, and carboxylic acid-based organic molecules. From the same viewpoint, the organic molecules more preferably include one or more organic molecules selected from the group consisting of azole-based organic molecules and cyan-based organic molecules, and still more preferably include one or more organic molecules selected from the group consisting of azole-based organic molecules. In the azole-based organic molecule (in particular, the imidazole-based organic molecule), since the organic molecule and the metal atom are bonded with a nitrogen atom interposed therebetween as illustrated in FIG. 1D, the adsorption rate of gas (in particular, carbon dioxide gas) is higher.

The azole-based organic molecules constituting the MOF include an organic molecule selected from the group consisting of imidazole, benzimidazole, triazole, and purine. From the viewpoint of further improving the gas adsorption rate, imidazole, benzimidazole, and purine are preferable, imidazole and benzimidazole are more preferable, and imidazole is still more preferable.

The azole-based organic molecule may or may not have a substituent.

Examples of the substituent that may be possessed by the azole-based organic molecule include one or more substituents selected from the group consisting of hydrophobic groups such as an alkyl group, a halogen atom, a nitro group, a phenyl group, a pyridyl group, and a cyano group, and hydrophilic groups such as an amino group and a carboxyl group.

The alkyl group is, for example, an alkyl group having 1 to 5 (in particular, 1 to 3) carbon atoms. Specific examples of the alkyl group include a methyl group, an ethyl group, an n-propyl group, an isopropyl group, an n-butyl group, an isobutyl group, a sec-butyl group, a tert-butyl group, and an n-pentyl group.

Examples of the halogen atom include a fluorine atom, a chlorine atom, and a bromine atom.

From the viewpoint of further improving the gas adsorption rate, the azole-based organic molecules constituting the MOF are preferably selected from the group consisting of azole-based organic molecules having no substituent and azole-based organic molecules having only a hydrophobic group (in particular, an alkyl group or a nitro group) if having a substituent, and more preferably selected from the group consisting of azole-based organic molecules having only a hydrophobic group (in particular, an alkyl group).

Examples of the azole-based organic molecules constituting the MOF include imidazole-based molecules represented by the following general formula (1), benzimidazole-based molecules represented by the following general formula (2), triazole-based molecules represented by the following general formulas (3) and (4), and purine-based molecules represented by the general formula (5).

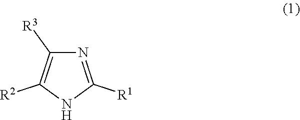

In the formula (1), R¹ to R³ are each independently a hydrogen atom; a hydrophobic group such as an alkyl group, a halogen atom, a nitro group, a phenyl group, a pyridyl group, or a cyano group; or a hydrophilic group such as an amino group or a carboxyl group, and from the viewpoint of further improving the gas adsorption rate, a hydrogen atom or the hydrophobic group is preferable, and a hydrogen atom, an alkyl group, a halogen atom, a nitro group, or a cyano group is more preferable. In a more preferred embodiment from the same viewpoint, R¹ is a hydrogen atom, an alkyl group, or a nitro group, and R² and R³ are each a hydrogen atom, an alkyl group, a halogen atom, or a nitro group. In a further preferred embodiment from the same viewpoint, R¹ is an alkyl group, and R² and R³ are each a hydrogen atom.

Specific examples of the imidazole-based molecule represented by the general formula (1) include the following compounds.

Imidazole, methylimidazole (in particular, 2-methylimidazole), ethylimidazole, nitroimidazole, aminoimidazole, chloroimidazole, bromoimidazole, imidazole carbonitrile.

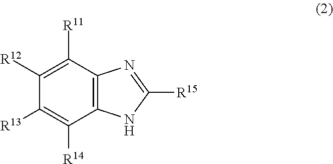

In the formula (2), R¹¹ to R¹⁵ are each independently a hydrogen atom; a hydrophobic group such as an alkyl group, a halogen atom, a nitro group, a phenyl group, a pyridyl group, or a cyano group; or a hydrophilic group such as an amino group or a carboxyl group, and from the viewpoint of further improving the gas adsorption rate, a hydrogen atom or the hydrophobic group is preferable, and a hydrogen atom, an alkyl group, a halogen atom, a nitro group, or a cyano group is more preferable. In a more preferred embodiment from the same viewpoint, R^{11,} R^{14,} and R¹⁵ are each a hydrogen atom, and R¹² and R¹³ are each independently a hydrogen atom, an alkyl group, a halogen atom, or a nitro group.

Specific examples of the benzimidazole-based molecule represented by the general formula (2) include the following compounds.

Benzimidazole, chlorobenzimidazole, dichlorobenzimidazole, methylbenzimidazole, bromobenzimidazole, nitrobenzimidazole, aminobenzimidazole, benzimidazole carbonitrile.

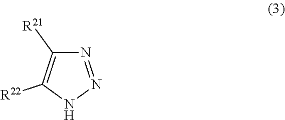

In the formula (3), R²¹ to R²² are each independently a hydrogen atom; a hydrophobic group such as an alkyl group, a halogen atom, a nitro group, a phenyl group, a pyridyl group, or a cyano group; or a hydrophilic group such as an amino group or a carboxyl group, and from the viewpoint of further improving the gas adsorption rate, a hydrogen atom or the hydrophobic group is preferable, and a hydrogen atom is more preferable.

Specific examples of the triazole-based molecule represented by the general formula (3) include the following compound.

### 1,2, 3-Triazole

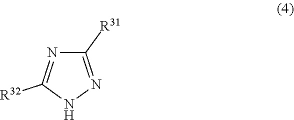

In the formula (4), R³¹ to R³² are each independently a hydrogen atom; a hydrophobic group such as an alkyl group, a halogen atom, a nitro group, a phenyl group, a pyridyl group, or a cyano group; or a hydrophilic group such as an amino group or a carboxyl group, and from the viewpoint of further improving the gas adsorption rate, a hydrogen atom or the hydrophobic group is preferable, and a hydrogen atom is more preferable.

Specific examples of the triazole-based molecule represented by the general formula (4) include the following compound.

### 1,2, 4-Triazole

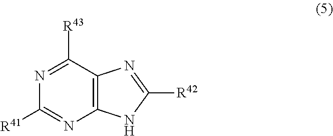

In the formula (5), R⁴¹ to R⁴³ are each independently a hydrogen atom; a hydrophobic group such as an alkyl group, a halogen atom, a nitro group, a phenyl group, a pyridyl group, or a cyano group; or a hydrophilic group such as an amino group or a carboxyl group, and from the viewpoint of further improving the gas adsorption rate, a hydrogen atom or the hydrophobic group is preferable, and a hydrogen atom is more preferable.

Specific examples of the purine-based molecule represented by the general formula (5) include the following compound.

### Purine

As the cyan-based organic molecule, potassium ferricyanide, potassium ferrocyanide, hydrocyanic acid, or the like can be used.

As the carboxylic acid-based organic molecule, terephthalic acid, benzenetricarboxylic acid, benzenedicarboxylic acid, or the like can be used.

The metal atoms constituting the MOF are metal atoms including a metal atom capable of constituting the metal oxide 2, and are, for example, selected from the group consisting of a zinc atom, a copper atom, a nickel atom, an iron atom, an indium atom, an aluminum atom, a cobalt atom, a praseodymium atom, a cadmium atom, a mercury atom, and a manganese atom. From the viewpoint of further improving the gas adsorption rate, the metal atoms are preferably selected from the group consisting of a zinc atom, a cobalt atom, and an iron atom, more preferably selected from the group consisting of a zinc atom and a cobalt atom, and still more preferably a zinc atom. The compound that provides such a metal atom is not particularly limited, and examples thereof include zinc nitrate, copper nitrate, aluminum nitrate, and nickel nitrate.

The combination of an organic molecule and a metal atom in the MOF is not particularly limited, but from the viewpoint of further improving the gas adsorption rate, preferably the following combinations (C1) to (C3), and more preferably the following combination (C1):
combination (C1)=a combination of an imidazole-based molecule (in particular, 2-methylimidazole and/or nitroimidazole) represented by the general formula (1) and one or more metal atoms selected from the group consisting of a zinc atom and an iron atom (in particular, a zinc atom);
combination (C2)=a combination of an imidazole-based molecule (in particular, 2-methylimidazole and/or nitroimidazole) represented by the general formula (1) and one or more metal atoms selected from the group consisting of a zinc atom and a cobalt atom (in particular, a zinc atom); and
combination (C3)=a combination of a benzimidazole-based molecule represented by the general formula (2) and one or more metal atoms selected from the group consisting of a zinc atom and a cobalt atom.

The ratio between the organic molecule and the metal atom in the MOF is not particularly limited, but is usually determined by the kind of the organic molecule and the kind of the metal atom constituting the MOF.

For example, a MOF containing only an imidazole-based molecule (Im) (for example, an imidazole-based molecule represented by the general formula (1)) and one or more divalent metal atoms (M¹) selected from the group consisting of a zinc atom, a cobalt atom, and an iron atom can be represented by the composition formula: M¹(Im)₂;
for example, a MOF containing only a benzimidazole-based molecule (bIm) (for example, a benzimidazole-based molecule represented by the general formula (2)) and one or more divalent metal atoms (M¹) selected from the group consisting of a zinc atom, a cobalt atom, and an iron atom can be represented by a composition formula M¹(bIm)₂;
for example, a MOF containing only a triazole-based molecule (Tra) (for example, a triazole-based molecule represented by the general formula (3) and/or (4)) and one or more divalent metal atoms (M¹) selected from the group consisting of a zinc atom, a cobalt atom, and an iron atom can be represented by the composition formula: M¹(Tra)₂; and
for example, a MOF containing only purine-based molecule (Pur) (for example, a triazole-based molecule represented by the general formula (5)) and one or more divalent metal atoms (M¹) selected from the group consisting of a zinc atom, a cobalt atom, and an iron atom can be represented by the composition formula M¹(Pur)₂.

Also, for example, a MOF containing only an imidazole-based molecule (Im) (for example, an imidazole-based molecule represented by the general formula (1)), a benzimidazole-based molecule (bIm) (for example, a benzimidazole-based molecule represented by the general formula (2)), and one or more divalent metal atoms (M¹) selected from the group consisting of a zinc atom, a cobalt atom, and an iron atom can be represented by a composition formula M¹(Im)ₓ(bIm)_{y} (wherein x+y=2).

The MOF constituting the MOF film 1 usually has a pore size of 1 Å to 50 Å. A MOF having a pore size appropriate from the viewpoint of characteristics depending on the application can be used. For example, in the case of a sensor using the MOF film of the present description, a MOF having a pore size close to the size of the target gas molecule is desirable. In the case of a carbon dioxide sensor, a MOF having a pore size of 2 Å to 5 Å, more preferably 2 Å to 4 Å, which is close to the molecular size of a carbon dioxide molecule of 3.3 Å, is desirable. In addition, when a polyamine such as polyethyleneimine is supported to form a carbon dioxide adsorption filter, a MOF having a pore size of 5 Å to 20 Å, more preferably 10 Å to 15 Å is preferable in consideration of the unit structure of the polyamine.

The pore size depends on the kinds of the organic molecule and the metal atom constituting the MOF. Thus, the pore size can be adjusted by selecting the kinds of organic molecule and metal atom.

In the present description, the pore size is defined as “the diameter of the largest sphere that can be contained inside a crystal in which each atom is assumed to be a rigid sphere with a van der Waals radius”, and is a pore size in a state where no molecule is contained in the pores. Thus, the pore size can be calculated from the crystal structure. Such a pore size is described as dₚ (Å) in Table 1 of the following document, and the value described in the document can be used:

ANH PHAN et al., “Synthesis, Structure, and Carbon Dioxide Capture Properties of Zeolitic Imidazolate Frameworks” (ACCOUNTS OF CHEMICAL RESEARCH 58 67 January 2010Vol. 43, No. 1)

The MOF constituting the MOF film 1 may be, for example, the following MOF:
ZIF-1 (composition formula: Zn(Im)₂);
ZIF-4 (composition formula: Zn(Im)₂);
ZIF-7 (composition formula: Zn(bIm)₂);
ZIF-8 (composition formula: Zn(mIm)₂);
ZIF-9 (composition formula: Co(bIm)₂);
ZIF-14 (composition formula: Zn(eIm)₂);
ZIF-81 (composition formula: Zn(cbIm) (nIm));
ZIF-75 (composition formula: Co(mbIm) (nIm));
ZIF-77 (composition formula: Zn(nIm)₂); and
ZIF-81 (composition formula: Zn(brbIm) (nIm)).

Here, abbreviations in the composition formula represent the following compounds.

Im: imidazole, bIm: benzimidazole, mIm: methylimidazole, eIm: ethylimidazole, nIm: nitroimidazole, cbIm: chlorobenzimidazole, brbIm: bromobenzimidazole.

The MOF film 1 may include an adsorbent. For example, the MOF film 1 may support an adsorbent in a crystal lattice constituting the MOF film. The adsorbent is not particularly limited as long as it can adsorb gas (in particular, carbon dioxide gas), and any adsorbent used in the field of gas adsorption can be used. As the adsorbent, an amine compound is preferably used from the viewpoint of adsorption of carbon dioxide gas. The amine compound is not particularly limited as long as it is a substance having an amino group, and an amino group-containing organic compound is usually used. The weight average molecular weight of the amino group-containing organic substance is not particularly limited, and may be, for example, 100 or more. The weight average molecular weight of the amino group-containing organic substance is 300 or more, and preferably 500 or more, from the viewpoint of preventing a decrease in the capability of adsorbing carbon dioxide gas due to volatilization. The upper limit of the weight average molecular weight is not particularly limited, and the weight average molecular weight may be usually 10,000 or less, and particularly 1000 or less. Specific examples of the amino group-containing polymer include polyethyleneimine, polyamidoamine, and polyvinylamine. The amino group-containing polymer may be linear or branched, and is preferably branched from the viewpoint of further improving the capability of adsorbing carbon dioxide gas.

The adsorbent is preferably polyethyleneimine, particularly preferably branched polyethyleneimine, from the viewpoint of further improving the capability of adsorbing carbon dioxide gas.

The amine value of the amine compound (in particular, the amino group-containing polymer) is not particularly limited, and is usually 15 to 25 mmol/g·solid, and from the viewpoint of further improving gas (in particular, carbon dioxide gas) adsorbability, the amine value is preferably 17 to 19 mmol/g·solid.

As the amine value, a value measured by a neutralization method calculated from the amount of hydrochloric acid necessary for neutralizing the amine compound is used.

In the present description, as illustrated in FIG. 1C, the MOF film 1 preferably has lattice defects while having a crystal structure (or crystal lattice). The lattice defect means that, in the crystal lattice of the MOF crystal, there is a missing metal and/or a missing organic molecule in a part (in particular, a part of the surface). When the MOF film 1 has lattice defects, gas molecules easily enter the inside of the MOF film 1, and thus the gas adsorption rate is further increased.

The MOF film 1 can be produced by the following method:

Heating and application of an ultrasonic wave are performed while the metal oxide is immersed in a solution containing organic molecules. For example, in a container with a lid, of polypropylene, stainless steel, or the like, heating and application of an ultrasonic wave are performed while the metal oxide is being brought into contact with the organic molecule solution.

The organic molecule is an organic molecule constituting the MOF film, and may be selected from the organic molecules described above.

The metal oxide is a metal oxide capable of providing metal atoms constituting the MOF film, and may be selected from the metal oxides described above.

The concentration of the organic molecule in the solution is not particularly limited as long as the MOF can be formed, and may be, for example, 5 g/L or more, preferably 50 g/L or more, and more preferably 120 g/L or more. The upper limit of the concentration of the organic molecule is not particularly limited, and the concentration may be usually 200 g/L or less, and particularly 150 g/L or less.

The solvent constituting the solution is not particularly limited as long as it is a solvent capable of dissolving the predetermined organic molecule, and examples thereof include organic solvents such as N,N-diethylformamide, N,N-dimethylformamide, methanol, and ethanol; and water.

The formation of the film (for example, immersion) is performed under heating. The heating temperature is usually 40° C. or higher, and from the viewpoint of further improving the gas adsorption rate, the heating temperature is preferably 50° C. or higher, more preferably 55° C. or higher, still more preferably 80° C. or higher, and particularly preferably 140° C. or higher. When the heating temperature is too low, no protrusions are formed on the surface of the MOF film, and if protrusions are formed, the average adjacent distance is too long. Thus, the gas adsorption rate decreases. The heating temperature may be usually 150° C. or lower.

The heating time is not particularly limited as long as the MOF can be formed, and may be, for example, 1 hour to 100 hours, particularly 1.5 hours to 24 hours.

The formation of the film (for example, immersion) is performed under the application of an ultrasonic wave. The frequency of the ultrasonic wave is usually 30 kHz or more. When the frequency is too low, no protrusions are formed on the surface of the MOF film, and if protrusions are formed, the average adjacent distance is too long. Thus, the gas adsorption rate decreases. The upper limit of the frequency is not particularly limited, and the frequency may be usually 100 kHz or less (in particular, 50 kHz or less).

The formation of the film (for example, immersion) may or may not be performed under pressure. Examples of the pressurization method include a method of pressurizing by heating in a container with a lid, of polypropylene, stainless steel, or the like. The pressure is not particularly limited, and may be, for example, 1 atm to 2 atm, particularly 1.2 atm to 1.5 atm. The heating method is not particularly limited, and may be electrical heating or heating by an ultrasonic wave or microwave.

When an adsorbent is supported on the MOF film 1, the adsorbent may be dissolved in a solution containing organic molecules, or the produced MOF film may be immersed in a solution containing the adsorbent. In this way, the adsorbent can be supported in the crystal lattice of the MOF film after drying. From the viewpoint of further improving the gas adsorption rate, it is preferable to produce a MOF film by dissolving the adsorbent in a solution containing organic molecules, and it is more preferable to immerse the MOF film produced by dissolving the adsorbent in a solution containing organic molecules, in a solution containing the adsorbent. In any case, the concentration of the adsorbent in the solution is not particularly limited, and may be, for example, 18 by volume or more, and from the viewpoint of further improving the gas adsorption rate, the concentration is preferably 5% by volume or more, and more preferably 10% by volume or more. The upper limit of the adsorbent concentration is not particularly limited, and the adsorbent concentration may be, for example, 50 vol % or less (in particular, 20 vol % or less).

When the MOF film is immersed in a solution containing an adsorbent, the solvent of the solution is not particularly limited as long as the adsorbent can be dissolved, and for example, water; or an organic solvent such as methanol, ethanol, or dimethylformamide may be used. Immersion of the MOF film in a solution containing an adsorbent may be repeated a plurality of times. By such immersion, a cleaning effect is also obtained. Although the MOF film may be washed with a solvent alone not containing an adsorbent, it is desirable to immerse the MOF film at least finally in a solution containing an adsorbent for adsorbent impregnation and then dry it.

After the MOF film is formed, it is preferable to remove the residual solvent and the adsorbed gas by heating. The heating is preferably performed in vacuum (or under a reduced pressure atmosphere). The heating temperature is not particularly limited, and may be, for example, 40° C. or higher, preferably 50° C. or higher, and more preferably 80° C. or higher. The upper limit of the heating temperature is not particularly limited, and the heating temperature may be usually 100° C. or lower. The drying time is not particularly limited, and may be, for example, 1 minute or more, preferably 10 minutes or more, and more preferably 30 minutes or more. The upper limit of the drying time is not particularly limited, and the drying time may be usually 200 minutes or less (in particular, 50 minutes or less).

By producing the MOF film 1 by the above-described method, protrusions can be formed at a predetermined average adjacent distance on the surface of the MOF film. Furthermore, lattice defects can be appropriately formed in the crystal structure (or crystal lattice) of the MOF film.

### Second Embodiment

The second embodiment of the present description provides a sensor using a composite film framework according to the first embodiment. The sensor of the present description may be a sensor for detecting gas (in particular, carbon dioxide gas) or odor. In the sensor of the present description, the gas adsorption rate of the MOF film is sufficiently improved as in the first embodiment. Thus, a sensor with high adsorbability is obtained, and as a result, a sensor (for example, a gas sensor and an odor sensor) with high reliability can be realized.

In the sensor of the present description, the MOF film can adsorb a large amount of gas by its protrusions (preferably protrusions and lattice defects), and the adsorption amount changes depending on the concentration of the surrounding gas. Thus, the MOF film can function as a sensitive film of the gas sensor.

Specifically, since the weight and electrical characteristics of the MOF change due to gas adsorption, the gas adsorption amount can be converted into an electrical signal, that is, a gas sensor can be obtained.

Preferred embodiments of the sensor of the present description are as follows.

For example, as the support, it is preferable to use a device whose frequency changes depending on the weight, such as a crystal oscillator or an oscillator using piezoelectric ceramic. A weight change-type gas sensor can be produced by sequentially forming a layer of the metal oxide 2 and the MOF film 1 on the support.

Further, for example, a weight change-type gas sensor can be produced by forming a zinc oxide layer (layer of the metal oxide 2) and a MOF film 1 such as the ZIF-8 on a crystal oscillator (support) according to the method in the first embodiment. The layer of the metal oxide 2 can be formed by a method such as a plating method, a CVD method, a vapor deposition method, or a sputtering method.

In the present embodiment, the constituent material of the layer of the metal oxide 2 is not limited to zinc oxide, and may be selected from metal oxides that are the same as the metal oxides described as the constituent material of the metal oxide 2 in the first embodiment.

The constituent material of the MOF film 1 can be determined by the target gas and the required sensitivity and selectivity. For example, an imidazole-based MOF such as ZIF-1, ZIF-4, ZIF-7, or ZIF-8 can be used as the MOF constituting the MOF film 1.

In order to reduce the influence of humidity for improving the accuracy of the sensor, and for obtaining appropriate response speed and recovery speed, the MOF film may be heated with a built-in heater (in particular, a heater for heating).

By arranging a plurality of kinds of MOF materials in an array on different oscillators, it is possible to produce a multi-gas sensor capable of simultaneously detecting a plurality of kinds of gases. Such a multi-gas sensor can be an odor sensor.

By forming a piezoelectric film and an electrode on a silicon substrate, next forming a heater wiring and a MOF film on the metal oxide, and then etching the silicon substrate, a MEMS type gas sensor and order sensor with reduced power consumption can be formed.

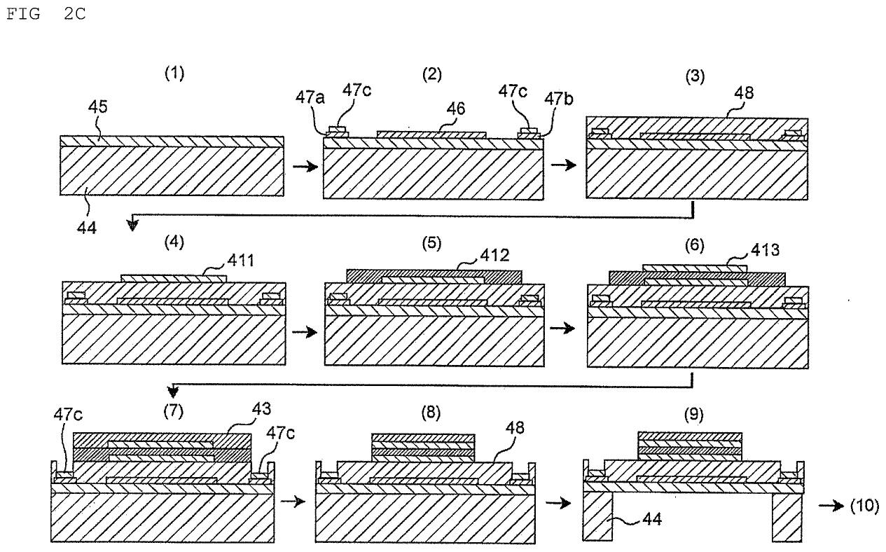

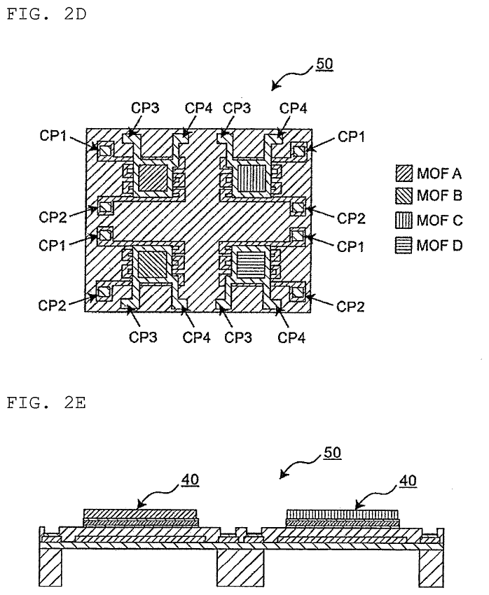

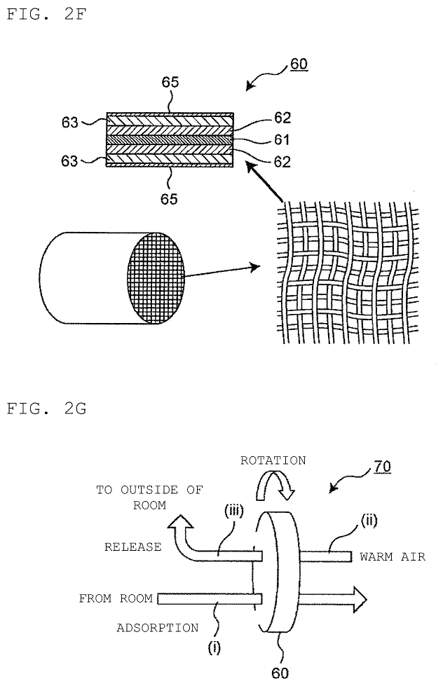

An example of a gas sensor of the present description is a MEMS type gas sensor illustrated in FIGS. 2A and 2B. FIGS. 2A and 2B are a schematic plan view and a schematic sectional view, respectively, of an example of a gas sensor according to the second embodiment of the present description.

The gas sensor 40 illustrated in FIGS. 2A and 2B includes a layer of a metal oxide 2 (not shown) formed on a piezoelectric oscillator 41 and a MOF film 43 of the layer of the metal oxide 2. In FIG. 2B, the layer of the metal oxide 2 is omitted. The piezoelectric oscillator 41 corresponds to the support and includes a lower electrode 411, a piezoelectric film 412, and an upper electrode 413. The MOF film 43 corresponds to the MOF film 1 in the first embodiment.

The gas sensor 40 usually further includes a silicon substrate 44, a support film 45 formed on the silicon substrate 44, a heater wiring 46 formed on the support film 45, a heater electrode 47a and an oscillator electrode 47b, wire bonding contact pads 47cformed on the heater electrode 47a and the oscillator electrode 47b, and an insulating layer 48 for insulating the heater wiring 46 from the piezoelectric oscillator 41.

In the gas sensor 40, CP1 is a connection terminal (positive) to the heater, CP2 is a connection terminal (negative) to the heater, CP3 is a connection terminal to the upper electrode of the oscillator, and CP4 is a connection terminal to the lower electrode of the oscillator. The wire bonding contact pad 47c functions as such a connection terminal.

The gas sensor 40 can be produced by, for example, the following method.

Specifically, first, a support film 45 is formed on a silicon substrate 44 (step (1)) as illustrated in FIG. 2C. Next, a heater wiring 46, a heater electrode 47a, and an oscillator electrode 47b are formed on the support film 45, and a wire bonding contact pad 47c is formed on each of the heater electrode 47a and the oscillator electrode 47b (step (2)). Further, an insulating layer 48 is formed to insulate the heater wiring 46 from the piezoelectric oscillator 41 described later (step (3)). A lower electrode 411 is formed on the insulating layer 48 (step (4)), a piezoelectric film 412 is formed on the lower electrode 411 (step (5)), and an upper electrode 413 is formed on the piezoelectric film 412 (step (6)). After a layer of a metal oxide 2 (not shown) is formed on the upper electrode 413, a MOF film 43 is formed on the layer of the metal oxide 2 (not shown), and a part of the insulating layer 48 is etched to expose the wire bonding contact pads 47c (step (7)). Thereafter, the members (MOF film 43, layer of the metal oxide 2 (not shown), upper electrode 413, piezoelectric film 412, and lower electrode 411) on the insulating layer 48 are partly etched (step (8)), and a part of the silicon substrate 43 is etched (step (9)), whereby a sensor 40 can be obtained (step (10)). FIG. 2C is a schematic process view illustrating an example of a method of producing a gas sensor according to the second embodiment of the present description.

The gas sensor 40 has reduced power consumption.

An example of a multi-gas sensor according to the present description is a MEMS type multi-gas sensor illustrated in FIGS. 2D and 2E. FIGS. 2D and 2E are a schematic plan view and a schematic sectional view, respectively, of an example of a multi-gas sensor according to the second embodiment of the present description.

The multi-gas sensor 50 illustrated in FIGS. 2D and 2E includes a plurality of (for example, four) gas sensors 40 illustrated in FIGS. 2A and 2B, and the four gas sensors 40 have MOF films including mutually different MOFs.

The method of producing the multi-gas sensor 50 is the same as the method of producing the gas sensor 40 except that a plurality of (for example, four) gas sensors 40 illustrated in FIGS. 2A and 2B are simultaneously produced, and the four gas sensors 40 have MOF films including mutually different MOFs. The MOFs of the four gas sensors 40 are mutually different MOFs corresponding to mutually different gases.

The multi-gas sensor 50 has suppressed power consumption. The multi-sensor 50 may function as an odor sensor.

### Third Embodiment

The third embodiment of the present description provides a gas adsorption filter using a MOF film according to the first embodiment. The gas adsorption filter of the present description may be a filter for adsorbing carbon dioxide gas. In the gas adsorption filter of the present description, the gas adsorption rate of the MOF film is sufficiently improved as in the first embodiment. Thus, a highly reliable gas adsorption filter can be realized.

The gas adsorption filter of the present embodiment has the same structure as the composite film framework according to the first embodiment except that an adsorbent different from the MOF is attached or supported on the surface of the MOF film.

Preferred embodiments of the gas adsorption filter of the present description are as follows.

As illustrated in FIG. 2F, the gas adsorption filter 60 includes a metal oxide layer 62 formed on a support 61 having a honeycomb structure, a MOF film 63 of the metal oxide layer 62, and an adsorbent 65 of the MOF thin film 63. In the present embodiment, the metal oxide layer 62 corresponds to the layer of the metal oxide 2 in the first embodiment. The MOF film 63 corresponds to the MOF film 1 in the first embodiment. The adsorbent 65 corresponds to the adsorbent in the first embodiment. FIG. 2F is a schematic diagram of an example of a gas adsorption filter according to the third embodiment of the present description.

By using the support 61 having a honeycomb structure, the surface area of the support itself can be extremely increased. In addition, as in the first embodiment, the gas adsorption rate is improved. Moreover, more MOF can be attached or supported. For this reason, it is possible to attach or support a larger amount of the adsorbent 65 while maintaining the adsorption rate of carbon dioxide gas per unit area. Thus, the capability of adsorbing carbon dioxide gas is significantly improved. In the present embodiment, since the metal oxide layer 62 acts as an adhesion layer, falling off of the MOF film 63 can be sufficiently prevented, and durability is improved.

Specifically, in the present embodiment, the effective surface area coming in contact with carbon dioxide is extremely increased by a combined effect of an increase in surface area due to the honeycomb structure of the support 61, and an increase in surface area due to surface irregularities and MOF crystals (internal irregularities (that is, pores)) based on the porosity and protrusions of the MOF film 63. As a result, the capability of adsorbing carbon dioxide gas is significantly improved. Moreover, by making the metal oxide layer porous, the capability of adsorbing carbon dioxide gas can be further improved.

By using an azole-based organic molecule (in particular, an imidazole-based organic molecule) or a cyan-based organic molecule as the organic molecule constituting the MOF film, the water resistance of the MOF is improved. Thus, also in a case where an adsorbent (in particular, an amino group-containing polymer) is supported, reliability is higher.

By forming the support 61 into the honeycomb structure, it is possible to improve the carbon dioxide adsorption capability while maintaining the pressure loss.

A gas adsorption filter of the present embodiment can be produced by forming a metal oxide layer 62 (layer of “metal oxide 2” in the first embodiment) and a MOF thin film 63 (“MOF film 1” in the first embodiment) on a support 61, then removing the residual solvent and the adsorbed gas through heating, and attaching or supporting an adsorbent 65. The heating is preferably performed in vacuum (or under a reduced pressure atmosphere).

Attaching or supporting of the adsorbent 65 can be achieved by immersing the MOF film in an aqueous solution of the adsorbent (in particular, amine compound) and then drying the MOF film. As a result, a film of the adsorbent 65 (in particular, amine compound) may be formed on the MOF film.

### Fourth Embodiment

The fourth embodiment of the present description provides a gas removal device (or gas removal system) including a gas adsorption filter 60 according to the third embodiment. The gas removal device of the present description may be a device (or system) for removing carbon dioxide gas. In the gas removal device of the present description, as in the third embodiment, the gas adsorption rate of the MOF film is sufficiently improved, and for example, the capability of adsorbing carbon dioxide gas can be significantly improved. The present description makes it possible to realize a small size, energy saving, low cost, and highly reliable gas removal device (in particular, a carbon dioxide gas removal device). The gas removal device of the present description can also be used for general air conditioning.

As shown in FIG. 2G, the gas removal device 70 of the present embodiment can release carbon dioxide gas in a room to the outside of the room through the following steps. FIG. 2G is a schematic diagram of an example of a gas removal device according to the fourth embodiment of the present description.

### Step (i):

By blowing air in a room onto the gas adsorption filter 60, carbon dioxide gas is adsorbed.

### Step (ii):

By blowing warmed air to the gas adsorption filter 60 or heating the gas adsorption filter 60, the adsorbed carbon dioxide gas is released.

Step (iii):

The released carbon dioxide gas is discharged to the outside of the room.

In the gas removal device 70, the adsorption of carbon dioxide (step (i)) and the release and discharge (steps (ii) and (iii)) may be simultaneously performed by using mutually different positions of the adsorption filter 60, as shown in FIG. 2G. At this time, the release position can be changed to the discharge position and the discharge position can be changed to the release position in the adsorption filter 60 by the rotation of the adsorption filter 60. As a result, carbon dioxide gas can be adsorbed, released, and discharged continuously.

In the gas removal device 70, the adsorption of carbon dioxide (step (i)) and the release and discharge (steps (ii) and (iii)) may be performed in series using the same position of the adsorption filter 60, as an alternative method.

The present description as described above encompasses the following preferable aspects.
<1> A metal-organic framework film having a surface covered with protrusions, the protrusions having an average adjacent distance p of 1 nm to 100 nm.
<2> The metal-organic framework film according to <1>, in which the protrusions have an average depth d of 1 nm to 100 nm.
<3> The metal-organic framework film according to <1> or <2>, in which the metal-organic framework film is disposed on a surface of a metal oxide.
<4> The metal-organic framework film according to <3>, in which a metal atom is shared at an interface between the metal oxide and a metal-organic framework constituting the metal-organic framework film by the metal oxide and the metal-organic framework.
<5> The metal-organic framework film according to <3> or <4>, in which the metal-organic framework film is a porous film based on coordinate bonds between organic molecules and metal atoms including a metal atom derived from the metal oxide.
<6> The metal-organic framework film according to <5>, in which the organic molecules include one or more organic molecules selected from the group consisting of azole-based organic molecules, cyan-based organic molecules, and carboxylic acid-based organic molecules.
<7> The metal-organic framework film according to <5> or <6>, in which the metal atoms include one or more metal atoms selected from the group consisting of zinc, copper, nickel, iron, indium, and aluminum.
<8> The metal-organic framework film according to any one of <3> to <7>, in which the metal oxide includes at least one metal oxide selected from the group consisting of zinc oxide, copper oxide, nickel oxide, iron oxide, indium oxide, and aluminum oxide.
<9> The metal-organic framework film according to any one of <3> to <8>, in which the metal oxide has a form of particles or a form of a molded body or a molded sintered body of the particles.
<10> The metal-organic framework film according to <9>, in which the particles have an average primary particle size of 2 μm to 25 μm.
<11> The metal-organic framework film according to any one of <1> to <10>, in which the metal-organic framework film has a film thickness t of 10 nm to 1000 nm.
<12> The metal-organic framework film according to any one of <1> to <11>, in which the metal-organic framework constituting the metal-organic framework film has a composition formula of Zn(mIm)₂.
<13> The metal-organic framework film according to any one of <1> to <12>, in which the metal-organic framework film is a material that adsorbs gas.
<14> The metal-organic framework film according to <13>, in which an amine compound is contained in the metal-organic framework film, and the gas is carbon dioxide gas.
<15> The metal-organic framework film according to <14>, in which the amine compound is an amino group-containing polymer having a weight average molecular weight of 100 or more.
<16> The metal-organic framework film according to <14> or <15>, in which the amine compound is polyethyleneimine.
<17> A method for producing a metal-organic framework film, the method including performing heating and application of an ultrasonic wave while immersing a metal oxide in a solution containing organic molecules.
<18> The method for producing a metal-organic framework film according to <17>, in which the metal-organic framework film according to any one of <1> to <16> is produced.
<19> The method for producing a metal-organic framework film according to <17> or <18>, in which the heating is heating at 40° C. or higher, and the ultrasonic wave is an ultrasonic wave having a frequency of 30 kHz or more.

Hereinafter, the present description will be described in more detail based on specific examples, but the present description is not limited to the following examples at all.

### EXAMPLES

### Example 1

### Formation of MOF Film

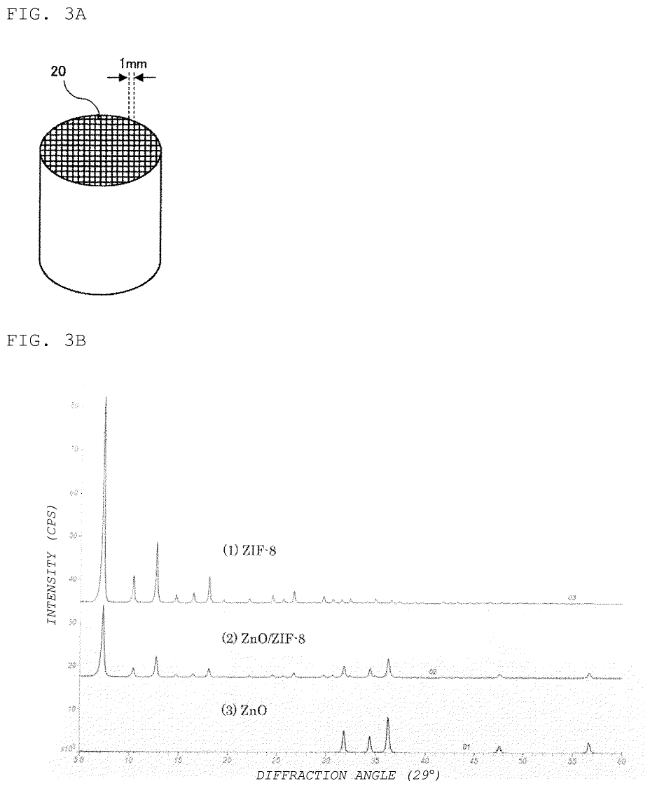

Zinc oxide powder (average primary particle size=11 μm) and a binder were mixed, the mixture was molded into a honeycomb filter shape by extrusion molding, and sintered at 1000° C. (FIG. 3A). This zinc oxide sintered body was used as a support, and a MOF film having a nano-protrusion framework was formed on the surface thereof. Specifically, the support was immersed in an ethanol solution containing raw materials (metal ions and organic molecules) for MOF synthesis, and heated at 60° C. for 2 hours while an ultrasonic wave of 40 kHz was being applied. Here, as the ethanol solution, an ethanol solution containing 10 mM zinc nitrate hexahydrate, 10 mM 2-methylimidazole, and 10 vol % polyethyleneimine (average molecular weight=600) was used. Next, the support was immersed for washing in an ethanol solution containing 10 vol % polyethyleneimine for 30 minutes. Thereafter, the support including the MOF film was taken out and dried at 80° C. for 30 minutes to obtain a filter.

### Confirmation of MOF Film by XRD Spectrum

A sample was collected from the outer surface of the filter, and it was confirmed by an X-ray diffraction (XRD) spectrum that a ZIF-8 film (composition formula: Zn(mIm)2) was formed. Specifically, as shown in FIG. 3B, in a case where the MOF film (ZIF-8) was formed on the surface of the zinc oxide layer (ZnO) (the filter obtained in Example 1), it was confirmed that the peaks of the X-ray diffraction (XRD) spectrum were at the same positions as the peak positions of the particles of ZIF-8 alone and the peak positions of the film of ZnO alone, that is, the filter was a composite framework having both ZIF-8 and Zno. In FIG. 3B, (1) shows an XRD spectrum of MOF (ZIF-8) alone, (2) shows an XRD spectrum of the sample in which the MOF (ZIF-8) film is formed on zinc oxide (ZnO), and (3) shows an XRD spectrum of zinc oxide (ZnO) alone.

### Confirmation of MOF Film by SEM Observation

The surface of the obtained filter was observed with a scanning electron microscope (SEM). The magnification was changed to obtain the SEM images of FIGS. 4A and 4B. In particular, from the SEM image of FIG. 4B, it became clear that protrusions are densely formed on the entire surface of the filter (surface of the MOF film).

The section of the protrusion can be observed from the broken part present in the MOF film. From the SEM image showing such a section, the average adjacent distance p and the average depth d of the protrusions were measured. Specifically, the distance between the two protrusions in each of 100 random adjacent pairs was measured, and the average adjacent distance p was determined. The average depth d and the average film thickness t were determined by measuring 100 random protrusions.

The average adjacent distance p was 20 nm, the average depth d was 25 nm, and the film thickness t was 20 nm.

### Example 2

### Formation of MOF Film

A filter was obtained in the same manner as in Example 1 except that zinc oxide powder having an average primary particle size of 1 μm was used.

### Confirmation of MOF Film by XRD Spectrum

The X-ray diffraction (XRD) spectrum was measured in the same manner as in Example 1, and it was confirmed that in the filter obtained in Example 2, the peaks of the X-ray diffraction (XRD) spectrum were at the same positions as the peak positions of the particles of ZIF-8 alone and the peak positions of the film of Zno alone, that is, the filter was a composite framework having both ZIF-8 and ZnO.

### Confirmation of MOF Film by SEM Observation

Observation was performed by SEM in the same manner as in Example 1. The magnification was changed to obtain the SEM images of FIGS. 5A and 5B. In particular, from the SEM image of FIG. 5B, it became clear that protrusions are densely formed on the entire surface of the filter (surface of the MOF film) of Example 2.

The average adjacent distance p and the average depth d of the protrusions, and the average film thickness t were measured from the SEM image in the same manner as in Example 1. Specifically, the distance between the two protrusions in each of 100 random adjacent pairs was measured, and the average adjacent distance p was determined. The average depth d and the average film thickness t were determined by measuring 100 random protrusions.

The average adjacent distance p was 15 nm, the average depth d was 10 nm, and the average film thickness t was 70 nm.

### Comparative Example 1

### Formation of MOF Film

A filter was obtained in the same manner as in Example 1 except that no ultrasonic wave was applied during immersion of the support in the ethanol solution.

### Confirmation of MOF Film by XRD Spectrum

The X-ray diffraction (XRD) spectrum was measured in the same manner as in Example 1, and it was confirmed that in the filter obtained in Comparative Example 1, the peaks of the X-ray diffraction (XRD) spectrum were at the same positions as the peak positions of the particles of ZIF-8 alone and the peak positions of the film of Zno alone, that is, the filter was a composite framework having both ZIF-8 and Zno.

### Confirmation of MOF Film by SEM Observation

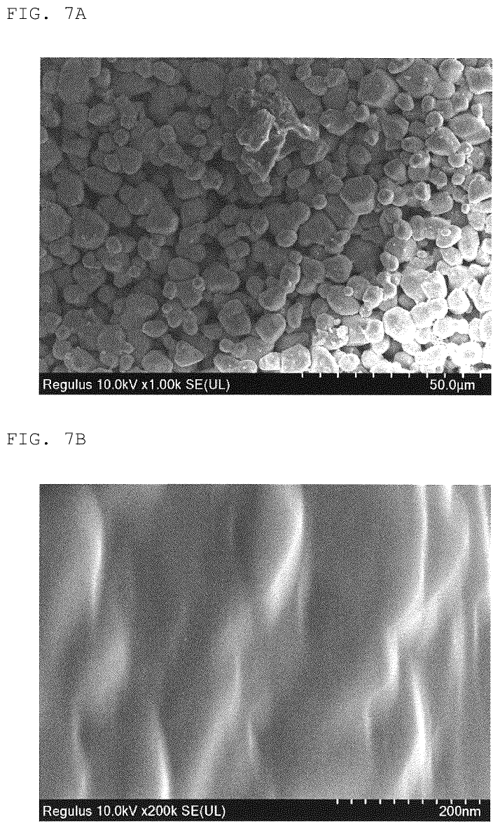

Observation was performed by SEM in the same manner as in Example 1. The magnification was changed to obtain the SEM images of FIGS. 6A and 6B. In particular, from the SEM image of FIG. 6B, it became clear that no protrusions were formed on the surface of the filter (surface of the MOF film) of Comparative Example 1, and the surface of the MOF film was smooth.

The average film thickness t was measured in the same manner as in Example 1. Specifically, the film thickness was measured at 100 random points to determine the average film thickness t.

The average film thickness t was 70 nm.

### Comparative Example 2

### Formation of MOF Film

A filter was obtained in the same manner as in Example 1 except that the heating temperature and the ultrasonic frequency were set to room temperature (25° C.) and 28 kHz, respectively, when the support was immersed in the ethanol solution.

### Confirmation of MOF Film by XRD Spectrum

The X-ray diffraction (XRD) spectrum was measured in the same manner as in Example 1, and it was confirmed that in the filter obtained in Comparative Example 2, the peaks of the X-ray diffraction (XRD) spectrum were at the same positions as the peak positions of the particles of ZIF-8 alone and the peak positions of the film of ZnO alone, that is, the filter was a composite framework having both ZIF-8 and Zno.

### Confirmation of MOF Film by SEM Observation

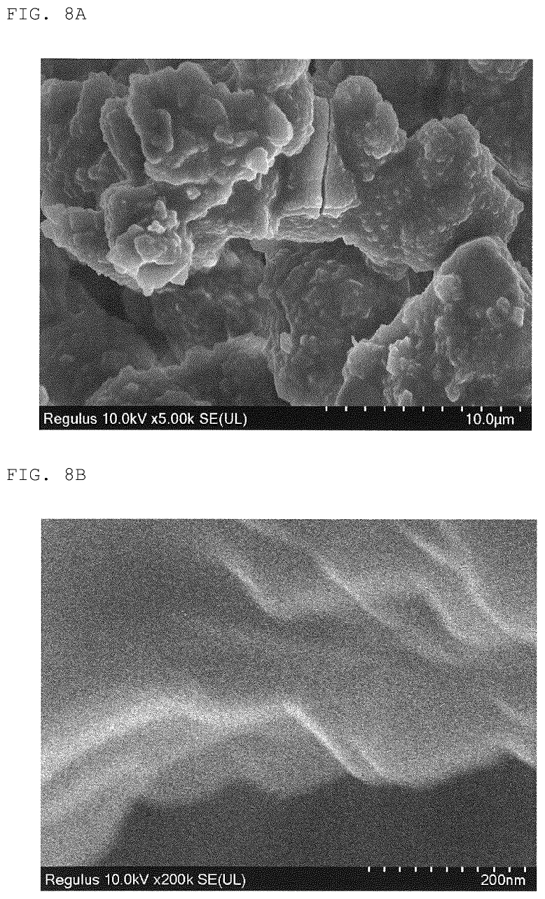

Observation was performed by SEM in the same manner as in Example 1. The magnification was changed to obtain the SEM images of FIGS. 7A and 7B. In particular, from the SEM image of FIG. 7B, it became clear that protrusions were not densely formed on the entire surface of the filter (surface of the MOF film) of Comparative Example 2.

The average adjacent distance p and the average depth d of the protrusions, and the average film thickness t were measured from the SEM image in the same manner as in Example 1. Specifically, the distance between the two protrusions in each of 100 random adjacent pairs was measured, and the average adjacent distance p was determined. The average depth d and the average film thickness t were determined by measuring 100 random protrusions.

The average adjacent distance p was 200 nm, the average depth d was 20 nm, and the average film thickness t was 100 nm.

### Comparative Example 3

Formation of MOF Film

Although an attempt was made to obtain a filter in the same manner as in Example 1 except that zinc oxide powder having an average primary particle size of 30 μm was used, the support collapsed when immersed in the ethanol solution.

### Comparative Example 4

### Formation of MOF Film

A filter was obtained in the same manner as in

Example 1 except that the heating temperature was set to room temperature 25° C. when the support was immersed in the ethanol solution.

### Confirmation of MOF Film by XRD Spectrum

The X-ray diffraction (XRD) spectrum was measured in the same manner as in Example 1, and it was confirmed that in the filter obtained in Comparative Example 4, the peaks of the X-ray diffraction (XRD) spectrum were at the same positions as the peak positions of the particles of ZIF-8 alone and the peak positions of the film of Zno alone, that is, the filter was a composite framework having both ZIF-8 and Zno.

### Confirmation of MOF Film by SEM Observation

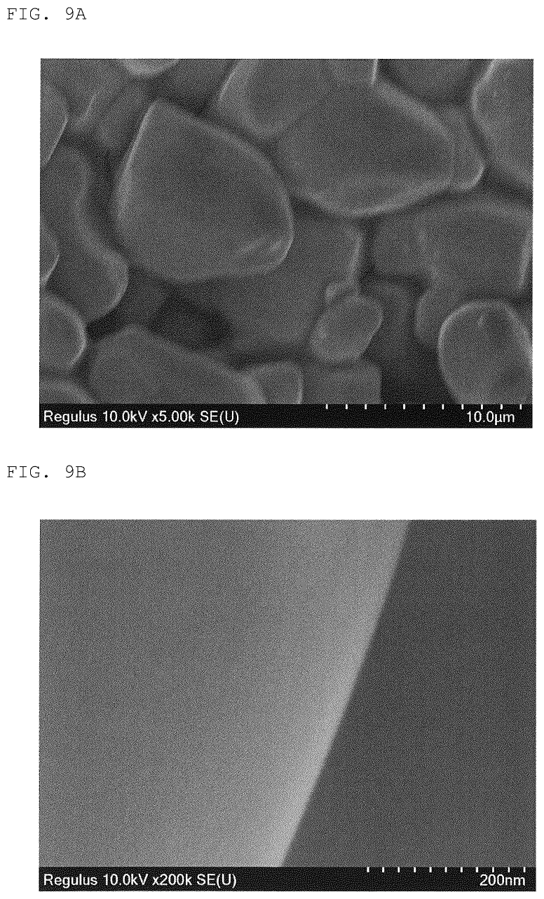

Observation was performed by SEM in the same manner as in Example 1. The magnification was changed to obtain the SEM images of FIGS. 8A and 8B. In particular, from the SEM image of FIG. 8B, it became clear that protrusions were not densely formed on the entire surface of the filter (surface of the MOF film) of Comparative Example 4.

The average adjacent distance p and the average depth d of the protrusions, and the average film thickness t were measured from the SEM image in the same manner as in Example 1. Specifically, the distance between the two protrusions in each of 100 random adjacent pairs was measured, and the average adjacent distance p was determined. The average depth d and the average film thickness t were determined by measuring 100 random protrusions.

The average adjacent distance p was 200 nm, the average depth d was 20 nm, and the average film thickness t was 100 nm.

### Comparative Example 5

### Formation of MOF Film

A filter was obtained in the same manner as in Example 1 except that the ultrasonic frequency was set to 28 kHz when the support was immersed in the ethanol solution.

### Confirmation of MOF Film by XRD Spectrum

The X-ray diffraction (XRD) spectrum was measured in the same manner as in Example 1, and it was confirmed that in the filter obtained in Comparative Example 5, the peaks of the X-ray diffraction (XRD) spectrum were at the same positions as the peak positions of the particles of ZIF-8 alone and the peak positions of the film of ZnO alone, that is, the filter was a composite framework having both ZIF-8 and Zno.

### Confirmation of MOF Film by SEM Observation

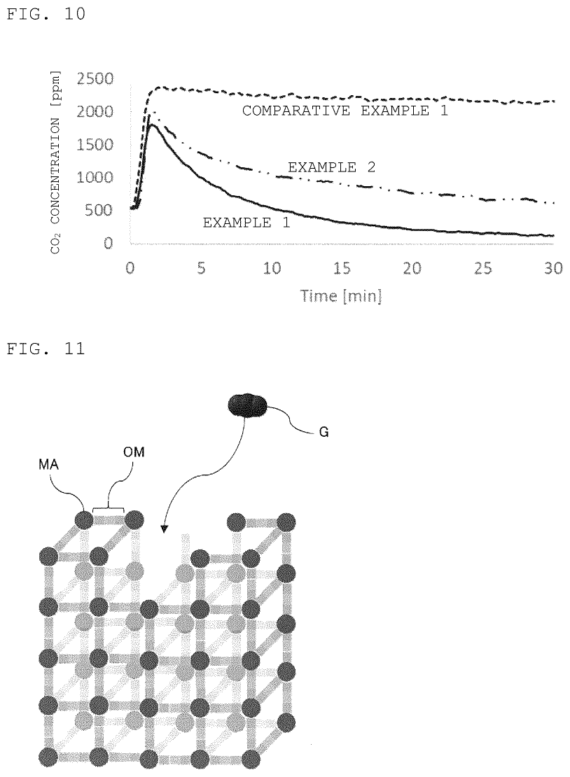

Observation was performed by SEM in the same manner as in Example 1. The magnification was changed to obtain the SEM images of FIGS. 9A and 9B. In particular, from the SEM image of FIG. 9B, it became clear that no protrusions were formed on the surface of the filter (surface of the MOF film) of Comparative Example 5, and the surface of the MOF film was smooth.

### (Carbon Dioxide Gas Adsorption Test)

### Method of Experiment

A filter sample was placed in a 12 L volume acrylic chamber, 24 mL of CO₂ gas was introduced, and the CO₂ concentration was monitored.

### Results

The CO₂ concentration measurement results are shown in FIG. 10. FIG. 10 is a graph showing evaluation results of the gas adsorption test in the examples and the comparative examples.

Specifically, the amount of carbon dioxide adsorbed at 30 minutes was as follows:
Example 1: concentration difference from no filter (2500 ppm): 2400 ppm=CO₂ adsorption of 28.8 mL;
Example 2: concentration difference from no filter (2500 ppm): 1800 ppm=CO₂ adsorption of 21.6 mL;
Comparative Example 1: concentration difference from no filter (2500 ppm): 350 ppm=CO₂ adsorption of 4.2 mL; and
Comparative Example 2: concentration difference from no filter (2500 ppm): 450 ppm=CO₂ adsorption of 4.8 mL.

As described above, the presence of the nano-protrusion framework increased the carbon dioxide adsorption rate. Furthermore, it was possible to increase the carbon dioxide adsorption rate by appropriately increasing the zinc oxide particle size.

Discussion 1: Acceleration of Entry of Gas into Nano-Protrusion Framework

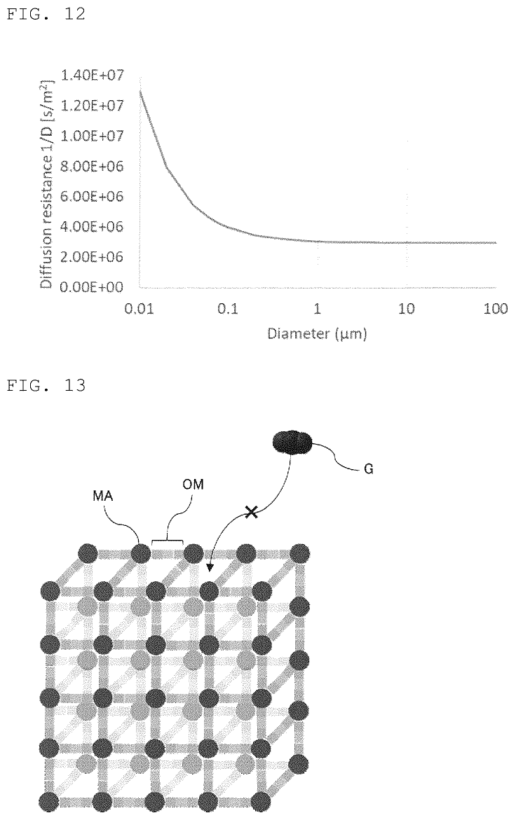

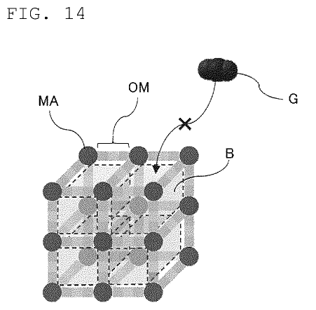

The MOF film is composed of metal ions and organic molecules, and typically has a crystal lattice without lattice defects as illustrated in FIG. 13. However, actually, lattice defects are present in some portions as illustrated in FIG. 11, and in the lattice defects, both a portion where the lattice is terminated with a metal and a portion where the lattice is terminated with an organic molecule are present, whereby the pores are widened. Gas molecules easily enter portions where the pores are widened. Since the MOF film of the present description has protrusions at a predetermined average adjacent distance, the surface area of the MOF film increases and lattice defects moderately increase, as illustrated in FIG. 1C. Thus, it is considered that the entry of gas molecules is further facilitated, and the gas adsorption rate as the gas adsorption filter is further increased. FIG. 11 is a schematic diagram of a MOF schematically illustrating a crystal structure of an actual MOF.

Discussion 2: Improvement in Gas Adsorption Rate by Voids between Particles

Since the gap between the particles constituting the support is large, the flow of the gas is improved, and the adsorption rate in the gas adsorption filter is improved. The diffusion resistance exhibited when gas flows in a straight hole on a capillary is as shown in FIG. 12. When the hole diameter is 1 μm or more, the diffusion resistance is small and the gas flow becomes smooth, as a result of which the gas adsorption rate is improved.

In the MOF filter of Example 2 prepared from zinc oxide particles having a particle size of 1 μm, voids between the particles are less than 1 μm at narrow portions. On the other hand, in the MOF filter of Example 1 prepared from zinc oxide particles having a particle size of 11 μm, voids are 1 μm or more at narrow portions. Accordingly, it is considered that in Example 1, the gas adsorption rate was further improved by the effect of voids in addition to the effect of the nano-protrusion framework. FIG. 12 is a graph showing the relationship between the gap dimension and the diffusion resistance.

### Discussion 3: Metal Oxide Particle Size of Base Material

In Example 1, also in a case where a MOF film is formed on a molded body obtained by extruding zinc oxide having a particle size of 11 μm and then firing the extruded zinc oxide, a shape equivalent to the shape before film formation (FIG. 3) is maintained.

In Comparative Example 3, when a MOF film is formed on a molded body obtained by extruding zinc oxide having a particle size of 30 μm and then firing the extruded zinc oxide, collapsing occurs.

As seen from the results, when the particle size is 11 μm, the filter shape can be maintained without a binder, whereas when the particle size is too large, the filter shape cannot be maintained.

It is considered that this is because when the particle size is too large, the contact area between the particles is small, whereby the strength is lowered, and in addition, due to the load at the time of MOF film formation, that is, the application of an ultrasonic wave, the structure is broken.

On the other hand, when the MOF film having the nano-protrusion structure is formed on the support, more MOF film is formed particularly at a portion where the gap between the particles is narrow as illustrated in FIG. 1A. Accordingly, it is apparent that metal oxide particles (for example, zinc oxide particles) having a particle size of 1 μm or more are required in order to obtain a void size of 1 μm or more.

The MOF film of the present description and the gas-adsorbing material having the MOF film are useful for a sensor (in particular, a gas or odor sensor), a gas adsorption filter, and a gas removal device.

### DESCRIPTION OF REFERENCE SYMBOLS

1: Metal-organic framework film (MOF film)
2: Metal oxide
11: Protrusion
12: Base
40: Gas sensor
50: Multi-gas sensor
60: Gas adsorption filter
61: Support
62: Metal oxide layer
63: Metal-organic framework film (MOF film)
65: Adsorbent
70: Gas removal device

1. A metal-organic framework film comprising:
a base; and
protrusions extending from a surface of the base, the protrusions having an average adjacent distance p of 1 nm to 100 nm.

2. The metal-organic framework film according to claim 1, wherein the protrusions have an average depth d of 1 nm to 100 nm.

3. The metal-organic framework film according to claim 1, wherein the metal-organic framework film has a film thickness t of 10 nm to 1000 nm.

4. The metal-organic framework film according to claim 1, wherein a metal-organic framework of the metal-organic framework film has a composition formula of Zn(mIm)₂.

5. The metal-organic framework film according to claim 1, wherein the metal-organic framework film is a material that adsorbs gas.

6. The metal-organic framework film according to claim 5, wherein
an amine compound is contained in the metal-organic framework film, and
the gas is carbon dioxide gas.

7. The metal-organic framework film according to claim 6, wherein the amine compound is an amino group-containing a polymer having a weight average molecular weight of 100 or more.

8. The metal-organic framework film according to claim 6, wherein the amine compound is polyethyleneimine.

9. A structure comprising:
a metal oxide; and
the metal-organic framework film according to claim 1 on a surface of the metal oxide.

10. The structure according to claim 9, wherein a metal atom is shared at an interface between the metal oxide and a metal-organic framework of the metal-organic framework film.

11. The structure according to claim 9, wherein the metal-organic framework film is a porous film having coordinate bonds between organic molecules and metal atoms including a metal atom derived from the metal oxide.

12. The structure according to claim 11, wherein the organic molecules include one or more organic molecules selected from azole-based organic molecules, cyan-based organic molecules, and carboxylic acid-based organic molecules.

13. The structure according to claim 11, wherein the metal atoms include one or more metal atoms selected from zinc, copper, nickel, iron, indium, and aluminum.

14. The structure according to claim 9, wherein the metal oxide includes at least of zinc oxide, copper oxide, nickel oxide, iron oxide, indium oxide, and aluminum oxide.

15. The structure according to claim 9, wherein the metal oxide has a form of particles or a form of a molded body or a molded sintered body of the particles.

16. The structure according to claim 15, wherein the particles have an average primary particle size of 2 μm to 25 μm.

17. A method for producing a metal-organic framework film, the method comprising: performing heating and application of an ultrasonic wave while immersing a metal oxide in a solution containing organic molecules.

18. The method for producing a metal-organic framework film according to claim 17, wherein the heating and application of the ultrasonic wave while immersing the metal oxide in the solution containing the organic molecules is conducted until the metal-organic framework film includes:
a base; and
protrusions extending from the base, the protrusions having an average adjacent distance p of 1 nm to 100 nm.

19. The method for producing a metal-organic framework film according to claim 17, wherein
a temperature of the heating is 40° C. or higher, and
the ultrasonic wave has a frequency of 30 kHz or more.
